(19) United States
(12) Patent Application Publication
(10) Pub. No.: US 2026/0063536 A1
(43) Pub. Date: Mar. 5, 2026

(54) SPECTROMETRIC MEASUREMENT METHOD AND ANALYZER FOR ASSESSING VARIABILITY EXHIBITED BY MEASURED SPECTRA

(71) Applicant: Endress+Hauser Optical Analysis, Inc., Ann Arbor, MI (US)

(72) Inventors: Randy Benedict, Ann Arbor, MI (US); Patrick Ehlers, Mölnlycke (SE); Nicholas Skriba, Jackson, MI (US); Joseph B. Slater, Dexter, MI (US); Marc Winter, Gelnhausen (DE); Oliver Link, Gundelfingen (DE); Sean J. Gilliam, Plymouth, MI (US); Jürgen Dessecker, Wittlingen (DE); Joel Patrow, Ann Arbor, MI (US)

(21) Appl. No.: 18/819,697

(22) Filed: Aug. 29, 2024

(51) Int. Cl. G01N 21/27

(52) U.S. Cl. CPC G01N 21/274; G01N 2201/121; G01N 2201/126; G01N 2201/12761

(57) ABSTRACT

A spectrometric measurement method includes: with multiple calibration light sources, exhibiting known emission spectra performing calibrations of multiple spectrometers; based on calibration data attained by these calibrations, assessing a variability exhibited by measured spectra determined by calibrated spectrometers; determining reference spectra of reference samples exhibiting known reference values of at least one measurand; based on the reference spectra and the previously assessed variability, determining synthetic spectra of reference samples exhibiting the previously assessed variability; and based on the measured reference spectra, the synthetic spectra and the corresponding reference value, determining and providing a model for determining measurement results of the at least one measurand. An analyzer for assessing the variability exhibited by measured spectra determined by calibrated spectrometers is configured to perform simulated calibrations.

### TECHNICAL FIELD

The present disclosure relates to spectrometric measurement methods, in particular methods for determining a model for determining measurement results of at least one measurand of a medium in a predetermined application based on measured spectra of the medium determined by calibrated spectrometers of a given type, and to spectroscopic analyzers for assessing a variability exhibited by measured spectra determined by calibrated spectrometers of the given type.

### BACKGROUND

Spectrometers of various types are currently employed in a large variety of different applications including industrial applications, as well as laboratory applications, to determine and to provide measurement results of various measurands of a medium. As an example, Raman spectrometers are employed to determine concentrations of components included in the medium, a pH-value of the medium, a melt index of the medium and/or a cell motility of the medium based on Raman spectra of the medium. As another example absorption spectrometers are, e.g., employed to determine concentrations of components included in the medium based on absorption spectra of the medium.

Spectrometers commonly include a light source transmitting light to a sample of the medium and a spectrometric unit receiving measurement light resulting from an interaction of the transmitted light with the medium and providing raw spectra of the received measurement light. The raw spectra are commonly provided to a signal processor determining measured spectra based on the raw spectra and an algorithm for determining spectral values of the measured spectra based on spectral values of the raw spectra. The measured spectra are, e.g., provided to an evaluation unit determining measurement results of the measurand based on a previously determined model for determining the measurement results based on spectral values of the measured spectra.

Models used in spectroscopy for determining measurement results of measurands are commonly determined based on a detailed mathematical analysis of experimentally determined reference spectra of reference samples of the medium exhibiting known reference values of the measurand. The determination of these models is, however, a laborious and time consuming process, in particular because of the considerable number of reference spectra required, the complexity of interdependencies between spectral values of the reference spectra and the reference values of the measurand, and/or because of influences of other properties affecting the spectral values and/or the spectral distribution of the reference spectra.

Correspondingly, there is a desire to use the same model on multiple spectrometers.

Different spectrometers do, however, exhibit different spectral responsivities. As a result, measured spectra of the same sample of the medium determined by different spectrometers may exhibit different absolute spectral values and/or different spectral distributions. Correspondingly, reusing the same model on multiple spectrometers requires for each of the spectrometers to be calibrated in a manner ensuring the calibrated spectrometers exhibit at least approximately identical spectral responsivities throughout their spectral measurement range.

Calibrations of spectrometers are commonly performed based on calibration measurements. As an example, calibration spectra of light emitted by calibration light sources exhibiting known emission spectra are, e.g., determined with the spectrometers to be calibrated, and the determinations of the spectral values of the measured spectra performed by the spectrometers are subsequently adjusted based on the calibration spectra and corresponding known emission spectra.

Calibration light sources used for responsivity calibrations, e.g., include broad band light sources, such as black body radiators or incandescent lamps, e.g., tungsten lamps. A disadvantage of this method is, however, that anything which may alter the spectral balance of the light emitted by the broad band light source and its presentation to the spectrometric unit of the respective spectrometer will contribute to a corresponding calibration error. As an example, when a tungsten bulb is used as a black body radiator, variations of a drive current supplied to the tungsten bulb, as well as aging of a filament of the tungsten bulb, may alter the emissivity of the black body radiator. In addition, light propagation path(s) of light emitted by the black body radiator may deviate from the light propagation path(s) of light emanating from a sample of the medium during spectroscopic measurements performed with the respective spectrometer. Thus, differences of the light propagation path(s) may also contribute to the calibration error.

As an alternative, calibration measurements may be performed with reference materials emitting known emission spectra in response to being illuminated by light having a predetermined excitation wavelength. In this case, the reference material is illuminated by the light source of the spectrometer to be calibrated and the adjustment of the determination of the measured spectra is performed based on the calibration spectra of the reference material determined by the spectrometer. Reference materials, e.g., fluorescent glasses, suitable for this purpose, e.g., include standard reference materials (SRM) developed for a number of different excitation wavelength by the National Institute of Standards and Technology (NIST) for relative intensity correction of Raman spectroscopic instruments. Reference materials illuminated by the light source of the spectrometer more truly account for the position of the sample and the corresponding light propagation path(s). A disadvantage of reference materials, such as fluorescent glasses, is, however, that they are sensitive to temperature. In addition, quantum effects commonly referred to as “quenching” may reduce the intensity and may also alter the spectral balance of the emission spectra of these reference materials.

Certain improvements with respect to responsivity calibrations may be achieved by a method for improving calibration transfer between multiple Raman analyzer installations disclosed in U.S. Pat. No. 11,287,384 B2. According to that method, a plurality of standard reference materials (SRM) is provided and emission spectra for each SRM sample are generated under factory-controlled conditions using identical measurement instrumentation and measurement parameters. The method further includes calibrating an intensity axis of Raman spectrometers at multiple Raman analyzer installations based on calibration spectra of the SRM samples determined by the respective Raman spectrometer and the previously determined emission spectrum of the SRM sample. U.S. Pat. No. 11,287,384 B2 further discloses accounting for a temperature dependency of the emission spectra of these reference materials based on temperature measurements of the samples, as well as methods of accounting for an illumination geometry applied to illuminate the sample and an excitation wavelength of the excitation light source illuminating the sample.

Even though at least some of the most relevant parameters, such as the temperature, illumination geometry and the excitation wavelength, may be accounted for during calibration, there still remains a number of other influencing factors affecting the measured spectra determined by calibrated spectrometers.

Amending the calibration procedure to properly account for all influencing factors may, however, be extremely difficult or even impossible. One of the reasons for this difficulty is that at least some of the influencing factors responsible for remaining variances of the spectral responsivities of calibrated spectrometers may be unknown. Another reason is that the time and effort involved in the individual calibrations increases with the number of known influencing factors to be taken into account. The latter may render correspondingly amended calibration procedures unfeasible for economical and/or efficiency reasons.

As a result, measured spectra of a single sample of a medium determined by multiple different calibrated spectrometers of the same type exhibit a variability caused by variations of the technical properties of the individual spectrometers and by variations of their calibration. In consequence, measurement errors of measurement results determined with the same model based on measured spectra determined by different calibrated spectrometers of the same type may vary significantly. In addition, measurement errors of measurement results determined with the same model based on measured spectra determined by calibrated spectrometers before and after they are re-calibrated may vary.

This adverse effect is especially large for Raman spectrometers because variations of the technical properties of Raman spectrometers have a large impact due to the extremely low signal to noise ratio inherent to Raman spectroscopic measurements caused by the notoriously low intensity of Raman scattered light.

Accordingly, there remains a need for further contributions in this area of technology.

As an example, there is a need for a method of determining a model for determining measurement results that is better suited to cope with the variability exhibited by measured spectra of the medium determined by different spectrometers of the same type.

As another example, there is a need to limit the additional time and effort involved in determining the model such that it repeatedly and reliably renders accurate measurement results based on measured spectra determined by different calibrated spectrometers of the same type.

As yet another example, there is a need for a spectrometric measurement method reliably providing accurate measurement results that can be performed based on a single model and/or in a more efficient and cost-effective manner.

### SUMMARY

The present disclosure includes a spectrometric measurement method comprising determining a model for determining measurement results of at least one measurand of a medium in a predetermined application based on measured spectra of the medium determined by calibrated spectrometers of a given type, each calibrated spectrometer including a spectrometric unit determining raw spectra of incident light according to a spectrometer-specific transfer function and a signal processor determining the measured spectra based on the raw spectra and a corrected algorithm including an algorithm and a correction for the algorithm determined during the last calibration of the respective spectrometer; the method comprising:
with multiple calibration light sources exhibiting known emission spectra performing calibrations of multiple spectrometers of the given type;
recording calibration data attained by these calibrations including for each of the multiple spectrometers recording at least one or each calibration spectrum of light emitted by one of the calibration light sources determined by the respective spectrometer during its calibration and the corresponding known emission spectrum of the respective calibration light source and including for each calibration spectrum that has been determined based on the corrected algorithm employed by the spectrometer determining the respective calibration spectrum recording the respective correction;
based on the calibration data assessing a variability exhibited by measured spectra determined by calibrated spectrometers of the given type;
with at least one spectrometer of the given type determining reference spectra of reference samples of the medium exhibiting known reference values of the measurand(s);
based on the reference spectra and the previously assessed variability determining synthetic spectra of reference samples exhibiting the previously assessed variability;
determining the model based on the measured reference spectra, the synthetic spectra and the corresponding reference values; and providing the model.

The model determination method disclosed herein provides the advantage that the variability of measured spectra determined by different calibrated spectrometers of the same type is properly assessed based on readily available calibration data and properly accounted for in the model determination based on the synthetic spectra exhibiting this variability.

This in turn provides the advantage that measurement errors of measurement results determined with the model are correspondingly small, and that measurement errors of measurement results determined based on measured spectra determined by different calibrated spectrometers of the same type are at least approximately of the same size. This provides the advantage that the model is universally applicable at all measurement sites within the predetermined application.

According to a first embodiment, assessing the variability comprises based on the calibration data assessing a function variability exhibited by spectrometer-specific transfer functions of spectrometers of the given type; and based on the calibration data and the function variability assessing a correction variability exhibited by corrections for the algorithm employed in calibrated spectrometers of the given type.

According to a second embodiment given by a refinement of the first embodiment, the method further comprises:
constructing a function generator generating synthetic functions exhibiting the function variability;
wherein constructing the function generator includes based on the calibration data designing the function generator such, that the generated synthetic functions constitute samples of the same statistical distribution as the spectrometer-specific transfer functions of spectrometers of the given type; and
assessing the function variability based on the synthetic functions generated by the function generator.

In certain embodiments of the method according to the first embodiment assessing the function variability comprises:
based on the calibration data determining the spectrometer-specific transfer function of each of the multiple spectrometers; or
determining the spectrometer-specific transfer function of each of the multiple spectrometers by based on at least one calibration spectrum determined by the respective spectrometer re-determining the corresponding raw spectrum based on which the respective calibration spectrum has been determined by the respective spectrometer by reverse processing the transformations performed by the algorithm or the corrected algorithm employed by the respective spectrometer to determine the respective calibration spectrum, and based on the re-determined raw spectrum and the known emission spectrum of the calibration light source used during the determination of the respective calibration spectrum determining the respective spectrometer-specific transfer function.

In certain embodiments of the method according to second embodiment, the method further comprises:
based on the calibration data determining the spectrometer-specific transfer function of each of the multiple spectrometers; and
designing the function generator based on the spectrometer-specific transfer function of each of the multiple spectrometers and/or by:
a) performing a method of interpreting the spectrometer-specific transfer functions of the multiple spectrometers as samples of a statistical distribution and based on these spectrometer-specific transfer functions training the function generator to determine the synthetic functions such, that their statistical probability of being samples of this statistical distribution is higher than a predetermined minimum probability;
b) performing a machine learning method, wherein the function generator learns the determination of the synthetic functions; or
c) with a generative adversarial network including a generator configured to learn the generation of functions resembling the spectrometer-specific transfer functions of the multiple spectrometers and a discriminator configured to learn to discriminate between the generated functions and the spectrometer-specific transfer functions of the multiple spectrometers performing a learning method, wherein the generator learns to generate the synthetic functions based on the feedback provided by the discriminator such, that the discriminator is unable to identify them as generated functions.

According to third embodiment, in certain embodiments of the method according to the first embodiment assessing the correction variability includes based on the calibration data and the previously assessed function variability performing the method steps of with an analyzer simulating calibrations of spectrometers of the given type, based on each simulated calibration determining the corresponding correction for the algorithm, and assessing the correction variability based on the corrections determined based on the simulated calibration.

A fourth embodiment includes a method according to the second and third embodiment, wherein:
each simulated calibration includes simulating at least one calibration measurement by with a spectrum generator configured to provide emission spectra corresponding to the known emission spectra of the calibration light sources included in the calibration data generating an emission spectrum, with the function generator generating a synthetic function, and based on the synthetic function provided by the function generator determining a synthetic raw spectrum of the emission spectrum provided by the spectrum generator; and
for each simulated calibration determining the corresponding correction for the algorithm includes based on the or each simulated calibration measurement performed during the respective simulated calibration determining the correction such, that calibration spectra determined based on the or each synthetic raw spectrum and a corrected algorithm including the algorithm and the correction each correspond to the respective emission spectrum based on which the respective synthetic raw spectrum has been determined.

In certain embodiments of the method according to the fourth embodiment each simulated calibration is performed based on a single one of the synthetic functions generated by the function generator, and/or performing the simulated calibrations includes based on each synthetic function generated by the function generator determining multiple corrections for the algorithm, that are each determined based on the same synthetic function and a different set of at least one emission spectrum provided by the spectrum generator.

In further embodiments of the method according to the fourth embodiment:
a) with the at least one spectrometer of the given type determining the reference spectra includes calibrating each spectrometer, based on the calibration of each spectrometer determining the spectrometer-specific transfer function of the respective spectrometer and the correction for the algorithm of the respective spectrometer, and with the calibrated spectrometer(s) determining and providing the reference spectra of the reference samples of the medium; and/or
b) determining the synthetic spectra includes for at least one or each measured reference spectrum performing the method steps of:
re-determining a light spectrum of the light received by the respective spectrometer based on which the respective reference spectrum has been determined by reverse processing the processing of the received light performed by the respective spectrometer or by performing a reverse processing method including providing the raw spectrum based on which the reference spectrum has been determined or re-determining the raw spectrum based on which the reference spectrum has been determined by reverse processing the transformations performed by the algorithm or the corrected algorithm employed by the respective spectrometer to determine the reference spectrum, and applying a backward transformation to the provided or re-determined raw spectrum that reverts the transformations performed by the spectrometer-specific transfer function of the respective spectrometer; and
based on the re-determined light spectrum determining multiple synthetic spectra, wherein each synthetic spectrum is determined by performing a forward processing method including determining a synthetic raw spectrum by applying one of the synthetic functions generated in the simulated calibrations to the re-determined light spectrum and determining the respective synthetic spectrum based on the synthetic raw spectrum and a corrected algorithm including the algorithm and one of the corrections that has determined based on one of the simulated calibrations.

In certain embodiments of the last mentioned embodiments, the reverse processing or the reverse processing method includes removing noise included in the reverse processed signals or removing noise include in the provided or re-determined raw spectra, and the forward processing method includes adding artificial noise to the forward processed signals or adding artificial noise to the synthetic raw spectra.

In certain embodiments of the method according to the third embodiment:
a) the algorithm includes a mapping algorithm assigning spectral lines to the spectral values of the raw spectra provided by the spectrometric unit and a responsivity algorithm determining the spectral values of the measured spectra based on the spectral values of the raw spectra and the spectral lines assigned to them;
b) each simulated calibration either includes a responsivity calibration or includes a calibration of the spectral axis followed by a responsivity calibration and each correction determined based the simulated calibration either includes a correction for the responsivity algorithm or includes a correction for the mapping algorithm and a correction for the responsivity algorithm;
c) the multiple calibration light sources include multiple responsivity calibration source exhibiting known emission spectra in a broad spectral range, multiple line calibration sources exhibiting known emission spectra including distinct features at known spectral lines, and/or multiple line and responsivity calibration sources exhibiting known emission spectra including distinct features at known spectral lines in a broad spectral range; and/or
d) the emission spectra provided by the spectrum generator including at least one of:
emission spectra that are each given by one of the known emission spectra of the multiple calibration light sources; and
synthetic emission spectra determined by the spectrum generator and/or including synthetic emission spectra exhibiting a variability corresponding to the variability exhibited by the known emission spectra of the line calibration source, synthetic spectra exhibiting a variability corresponding to the variability exhibited by the known emission spectra of the responsivity calibration sources, and/or synthetic spectra exhibiting a variability corresponding to the variability exhibited by the known emission spectra of the line and responsivity calibration sources.

In certain embodiments, determining the model comprises the method step of:
based on the measured reference spectra and the corresponding reference values determining a test model,
performing at least one of testing and refining the test model based on training data including at least some of the synthetic spectra and the corresponding reference values, and based on training data including at least some of the synthetic spectra and the corresponding reference values performing an iterative process of repeatedly performing a method step of testing the test model and a method step of refining the test model until measurement errors of measurement results determined based on the synthetic spectra and the refined model are smaller than a predetermined threshold; and
providing the model given by refined test model.

In further embodiments, the method further comprises a method step of verifying the model by:
with a different set of at least one spectrometer than the spectrometer(s) employed to determine the reference spectra determining additional reference spectra of reference samples of the medium exhibiting known reference values;
determining measurement errors of measurement results determined based on the additional reference spectra and the previously determined model; and
performing at least one of verifying the model when the measurement errors are smaller than a predetermined threshold; and refining the model and providing the refined model when the measurement errors exceed the predetermined threshold.

In certain embodiments, the method further comprises with at least one or multiple spectrometers to be employed at measurement sites in the predetermined application performing the method steps of calibrating each spectrometer, with each calibrated spectrometer determining and providing measured spectra of the medium and, based on the measured spectra and the previously determined model determining and providing measurement results of the measurand(s).

According to refinements of the last mentioned embodiments, the method further comprises at least one of:
a) at least once performing the method steps of calibrating at least one additional spectrometer, with each calibrated additional spectrometer determining measured spectra of the medium, and based on the measured spectra determined by the calibrated additional spectrometer(s) and the previously determined model determining and providing measurement results of the measurand(s);
b) at least once performing the method steps of re-calibrating at least one calibrated spectrometer and/or at least one calibrated additional spectrometer, with the or each re-calibrated spectrometer determining and providing measured spectra of the medium, and based on the measured spectra determined by the re-calibrated spectrometer(s) and the previously determined model determining and providing measurement results of the measurand(s);
c) at least once performing the method steps of replacing at least one calibrated spectrometer and/or at least one calibrated additional spectrometer by a replacement spectrometer, calibrating each replacement spectrometer, with each calibrated replacement spectrometer determining measured spectra of the medium, and based on the measured spectra determined by the calibrated replacement spectrometer(s) and the previously determined model determining and providing measurement results of the measurand(s).

The present disclosure further includes an analyzer for assessing a variability exhibited by measured spectra determined by calibrated spectrometers of a given type, each spectrometer including a spectrometric unit determining raw spectra of incident light according to a spectrometer-specific transfer function and a signal processor determining measured spectra based on the raw spectra and an algorithm, wherein the analyzer is configured to perform simulated calibrations of spectrometers of the given type and has been designed to perform the simulated calibrations based on calibration data determined by with multiple calibration light sources exhibiting known emission spectra performing calibrations of multiple spectrometers of the given type, the analyzer comprising:
a spectrum generator configured to provide emission spectra corresponding to the known emission spectra of the calibration light source included in the calibration data and/or including synthetic spectra determined by the spectrum generator and exhibiting a variability corresponding to the variability exhibited by known emission spectra of the multiple calibration light sources;
a soft sensor comprising a function generator and a processing unit;
wherein the function generator is configured to determine and to provide synthetic functions exhibiting a function variability exhibited by the spectrometer-specific transfer functions of spectrometer of the given type, wherein the function generator has been designed, has been trained or learned to generate the synthetic functions based on the calibration data such, that they constitute samples of the same statistical distribution as the spectrometer-specific transfer functions of the multiple spectrometers; and
wherein the processing unit is configured to determine and to provide synthetic raw spectra of the emission spectra provided by the spectrum generator based on the synthetic functions generated by the function generator; and
an analyzing unit configured to determine and to provide a correction for the algorithm for each simulated calibration performed by the analyzer by: based on the or each emission spectrum provided by the spectrum generator and the corresponding synthetic raw spectrum generated by the soft sensor during the respective simulated calibration determining the correction such, that calibration spectra determined based on the or each synthetic raw spectrum and a corrected algorithm including the algorithm and the correction correspond to the emission spectrum based on which the respective synthetic raw spectrum has been determined.

In certain embodiments of the analyzer:
the calibration light sources employed in the calibrations of the multiple spectrometers include multiple calibration light sources of the or each type of calibration light source employed in the calibrations;
the type(s) of calibration light source(s) employed include: responsivity calibration light sources, line calibration light sources and responsivity calibration light sources, and/or line and responsivity calibration light sources;
the spectrum generator includes a generator for the or each type of calibration light source employed; and
at least one or each generator included in the spectrum generator is:
configured to provide emission spectra that are each given by one of the known emission spectra of the multiple calibration light sources of the respective type;
configured to determine and to provide emission spectra given by normalized weighted sums of the known emission spectra of the multiple calibration light sources of the respective type; or
configured, trained or designed learn to determine and to provide emission spectra exhibiting a variability corresponding to the variability exhibited by known emission spectra of the multiple calibration light sources of the respective type.

In certain embodiments, the analyzer further comprises:
an input port for receiving measured reference spectra of reference sample determined by spectrometers of the given type,
a reverse-processing unit configured to reverse-process each reference spectrum and to thereby re-determine a light spectrum of light received by the spectrometric unit of the spectrometer based on which the reference spectrum has been determined by the respective spectrometer; and
a forward processing unit configured to forward-process the re-determined light spectra provided by the reverse processing unit and to thereby determine multiple synthetic spectra, wherein each synthetic spectrum is determined by the forward processing unit:
determining a synthetic raw spectrum by applying one the synthetic functions generated by the function generator during the simulated calibrations to the re-determined light spectrum; and
determining the respective synthetic spectrum by applying a corrected algorithm including the algorithm and one of the corrections that has determined by the analyzing unit based on one of the simulated calibrations to the synthetic raw spectrum.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken in junction with the accompanying drawings, wherein:

FIG. 1 shows a flow chart of a spectrometric measurement method according to the present disclosure;

FIG. 2 shows a flow chart of a method of determining a model according to the present disclosure;

FIG. 3 illustrates a calibrated spectrometer;

FIG. 4 illustrates a spectrometer performing a calibration measurement;

FIG. 5 shows a representative block diagram of the processing performed by calibrated spectrometers;

FIG. 6 shows a method of assessing a function variability according to the present disclosure;

FIG. 7 shows an analyzer according to the present disclosure;

FIG. 8 shows a method of determining synthetic spectra according to the present disclosure; and

FIG. 9 shows an iterative process of determining a model according to the present disclosure.

### DETAILED DESCRIPTION

The present disclosure includes a spectrometric measurement method of determining measurement results MR of at least one measurand of a medium in a predetermined application based on measured spectra Iₘ determined and provided by calibrated spectrometers S of a given type. The given type of spectrometer S may be, e.g., a Raman spectrometer configured to excite and operate upon Raman scattered light from the medium. Or, the type of spectrometer S may be, e.g., an absorption spectrometer configured to operate upon light transmitted through the medium (e.g., tunable diode laser absorption spectroscopy).

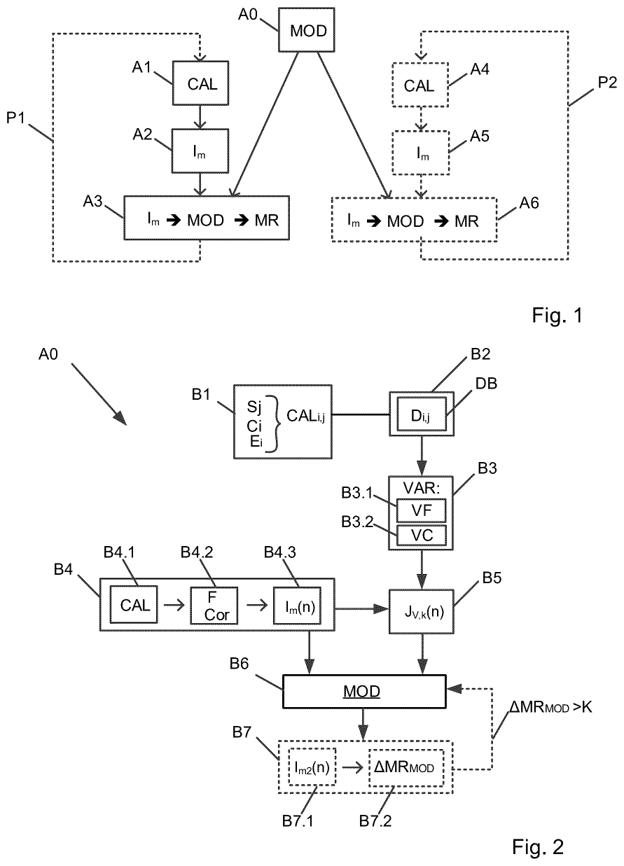

A flow chart of the spectrometric measurement method according to the present disclosure is shown in FIG. 1, which includes: for each spectrometer S of the given type to be employed at a measurement site in the predetermined application, performing a method step A1 of calibrating the spectrometer S; a method step A2 of, with the calibrated spectrometer S, determining and providing measured spectra Iₘ of the medium; and a method step A3 of, based on the measured spectra Iₘ determined by each of the calibrated spectrometers S, determining and providing measurement results MR of the at least one measurand based on a model MOD that has previously been determined for the predetermined application.

The present disclosure further includes a spectrometric measurement method comprising determining a model MOD for determining measurement results MR of at least one measurand of a medium based on measured spectra Iₘ of the medium determined and provided by calibrated spectrometers S of a given type in a predetermined application. A flow chart of the model determination method according to the present disclosure is shown in FIG. 2.

In certain embodiments, the model determination method shown in FIG. 2 is, e.g., performed in a preparatory method step A0 of the spectrometric measurement method according to the present disclosure shown in FIG. 1 and, subsequently, used to determine measurement results MR of the measurand(s) based on the measured spectra Iₘ determined by each one of the calibrated spectrometers S employed.

With respect to the methods according to the present disclosure, e.g., as shown in FIGS. 1 and 2, the predetermined application is, e.g., a specific process in the life science industry, in biotechnology, in the oil and gas industry, in the chemical industry, in the food and beverage industry, or in a process of another field. In either method, the measurand(s), e.g., include at least one of a concentration of a target analyte included in the medium, a pH-value of the medium, a melt index of the medium, a cell motility of the medium, and at least one other property of the medium.

In certain embodiments, the predetermined application is, e.g., specified by the measurand(s) to be measured and the application-specific type of the medium. Depending on the predetermined application, the at least one measurand, e.g., include(s) a concentration of at least one component included in the medium, a pH-value of the medium, a melt index of the medium, a cell motility of the medium, and/or at least one other property of the medium.

In certain embodiments, the predetermined application is, e.g., a liquid natural gas (LNG) application. In such a case, media of the application-specific type are liquid natural gases and the measurand(s), e.g., include the concentration of at least at least one component, e.g., methane (CH₄) and/or ethane (C₂H₆), included in the liquid natural gas.

In other embodiments, the predetermined application is, e.g., a biotechnological application, wherein mammalian cells producing an active component of a drug are grown in a cell culture medium. In such a case, media of the application-specific type are, e.g., cell culture media including mammalian cells and the measurand(s), e.g., include a glucose concentration, a lactate concentration, a viable cell density of the mammalian cells contained in the cell culture medium, and/or at least one other property of the medium.

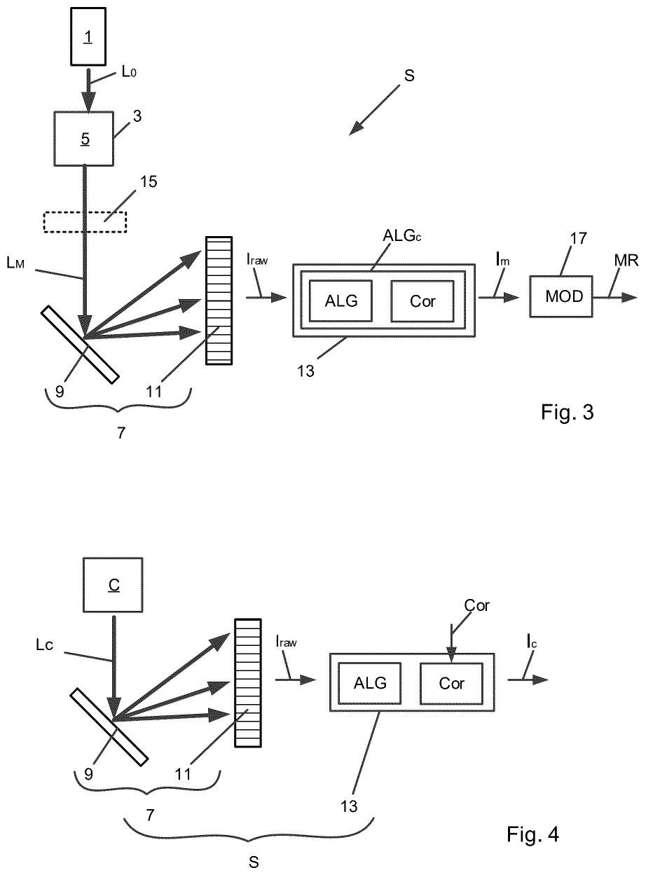

An exemplary embodiment of a calibrated spectrometer S of the given type is shown in FIG. 3. The exemplary spectrometer S shown includes a light source 1 transmitting light L₀ to a measurement region 3 configured to accommodate a sample 5 of the medium and a spectrometric unit 7 configured to receive measurement light L_{M} resulting from an interaction of the transmitted light L₀ with the medium and configured to determine and to provide raw spectra I_{raw} of the received measurement light L_{M}.

In certain embodiments, the spectrometric unit 7, e.g., includes a disperser 9, e.g., a diffractive or holographic grating, dispersing the incident measurement light L_{M}, and a detector 11 receiving the dispersed measurement light L_{M}. In certain embodiments, the detector 11, e.g., includes an array of detection elements, e.g., an array of charge coupled devices (CCD) or an array of photodiodes, each receiving a fraction of the dispersed light and determining and providing a detector signal corresponding to an intensity of the fraction of the dispersed light received by the respective detector element. In such embodiments, the raw spectra I_{raw} are, e.g., provided by the spectrometric unit 7 in form of the unprocessed detector signals provided by the individual detector elements or in form of pre-processed signals provided by a signal preprocessor processing the detector signals.

With respect to both methods according to the present disclosure shown in FIGS. 1 and 2, each spectrometer S is, e.g., given by a Raman spectrometer. In this case, the light source 1 of each spectrometer S is e.g., a monochromatic light source, e.g., a laser, configured to transmit excitation light L₀ having a predetermined excitation wavelength, e.g., a wavelength in the visual or near infrared wavelengths range. In certain embodiments, each Raman spectrometer, e.g., includes a filter 15, e.g., a notch-filter, configured to receive light emanating from the illuminated sample 5 and to provide measurement light L_{M} including Raman scattered light emanating from the illuminated sample 5 to the spectrometric unit 7. In at least one embodiment, the filter 15 is adapted to filter light having the predetermined excitation wavelength from the measurement light L_{M}.

In addition or as an alternative, each Raman spectrometer is, e.g., configured to determine and to provide the measured spectra Iₘ as intensity spectra representing the spectral intensities of the Raman scattered light emanating from the illuminated sample 5 in a predetermined spectral range, e.g., a wavelength range or a wavenumber range.

In alternative embodiments, each spectrometer S employed in the methods according to the present disclosure shown in FIGS. 1 and 2 is, e.g., given by an absorption spectrometer. In this case, the light source 1 is, e.g., broad band light source transmitting light L₀ having a broad spectral range through the sample 5, which is accommodated in the measurement region 3, e.g., light L₀ including wavelengths in the visual, ultraviolet and/or infrared range. In such embodiments, the measured spectra Iₘ of the measurement light L_{M} exiting the measurement region 3 are, e.g., determined as absorption spectra representing the spectral absorption of the medium as a function of the spectral line or as intensity spectra representing spectral intensity values of the measurement light L_{M}.

As a further alternative each spectrometer S used in methods shown in FIGS. 1 and 2 is, e.g., given by a dispersive spectrometer, by tunable diode laser spectrometer or by another type of spectrometer.

Regardless of the type of the spectrometers S used, each spectrometer S includes a signal processor 13, e.g., a computer, a microprocessor or another type of calculating unit, connected to and/or communicating with the spectrometric unit 7 and configured to determine and to provide measured spectra Iₘ of the medium based on the raw spectra I_{raw} provided by the spectrometric unit 7. In certain embodiments, the signal processor 13 is, e.g., located in the vicinity of the spectrometric unit 7. In alternative embodiments, the signal processor 13 is, e.g., located at a remote location or implemented in a cloud computing network. In either embodiment, determining the measured spectra Iₘ is, e.g., performed by the signal processor 13 based on an algorithm ALG for determining the spectral values of the measured spectra Iₘ based on the spectral values of the raw spectra I_{raw} provided by the spectrometric unit 7. The algorithm ALG is, e.g., implemented in each spectrometer S of the given type by the manufacturer.

In certain embodiments, the algorithm ALG, e.g., includes a mapping algorithm Alg-x assigning spectral lines to the spectral values of the raw spectra I_{raw} provided by the spectrometric unit 7 and a responsivity algorithm Alg-y determining the spectral values of the measured spectra Iₘ based on the spectral values of the raw spectra I_{raw} and the spectral lines assigned to them. The mapping algorithm Alg-x, e.g., includes a mapping function assigning the spectral lines to the detector signals. The responsivity algorithm Alg-y, e.g., includes a responsivity function for determining the spectral values of the measured spectra Iₘ at the corresponding spectral lines based on the spectral values of the raw spectra I_{raw} and the spectral lines assigned to them.

As shown in FIG. 1, each spectrometer S is calibrated in method step A1 before it is put into operation at a measurement site in the predetermined application. To this extent, calibration procedures known in the art for calibrating spectrometers of the given type are, e.g., employed. Each calibration CAL, e.g., includes, with the spectrometer S to be calibrated, performing at least one calibration measurement and based on the calibration measurement(s) determining a correction Cor for the algorithm ALG. The thus determined correction Cor is then implemented in the respective spectrometer S, and the signal processor 13 of the calibrated spectrometer S subsequently performs the determination of the measured spectra Iₘ based on a corrected algorithm ALGc including the algorithm ALG and the correction Cor.

Each calibration measurement is, e.g., performed as shown in FIG. 4 by, with the spectrometer S, determining a calibration spectrum Ic of light Lc emitted by a calibration light source C exhibiting a known emission spectrum. In case the spectrometer S has never been calibrated before, the respective calibration spectrum Ic is, e.g., determined by the uncalibrated spectrometer S based on the algorithm ALG. In case the spectrometer S has been calibrated before, the respective calibration spectrum Ic is, e.g., determined by the previously calibrated spectrometer S based on the corrected algorithm ALGc including the correction Cor determined during the previous calibration of the respective spectrometer S. As an alternative available for spectrometers S that are configured accordingly, the respective calibration spectrum Ic is, e.g., provided in form of the corresponding raw spectrum I_{raw} provided by the spectrometric unit 7 or in form of a spectrum determined based on the raw spectrum I_{raw} and the uncorrected algorithm ALG.

Based on the or each calibration spectrum Ic determined by the respective spectrometer S, the correction Cor is preferably determined such that calibration spectra Ic of light Lc emitted by the respective calibration light source C determined by the respective spectrometer S based on the corrected algorithm ALGc correspond to the known emission spectrum of the respective calibration light source C.

Considering that the spectral responsivity of each spectrometer S is different, each calibration CAL preferably includes a calibration of the spectral responsivity of the respective spectrometer S. Calibrations of the spectral responsivity are, e.g., performed as shown in FIG. 4 with calibration light sources C that are given by responsivity calibration sources exhibiting the known emission spectrum in a broad spectral range.

In certain embodiments, the responsivity calibration sources employed, e.g., include at least one broad band light source, at least one black body radiator and/or at least one type of incandescent lamp, e.g., a tungsten lamp. In addition or as an alternative, in certain embodiments, the responsivity calibration sources, e.g., include at least one calibration light source C including an excitation light source illuminating a reference material emitting a known emission spectrum in response to being illuminated by the excitation light source. In such embodiments, the excitation light source is, e.g., given by the light source 1 of the spectrometer S to be calibrated and/or the reference material is, e.g., accommodated in the measurement region 3 of the respective spectrometer S. The reference materials employed for this purpose, e.g., include standard reference materials (SRM), e.g., fluorescent glasses, developed by the National Institute of Standards and Technology (NIST) for relative intensity correction of Raman spectroscopic instruments.

For each calibration CAL including the calibration of the spectral responsivity of the respective spectrometer S, determining the correction Cor, e.g., includes determining a correction Cor-y for the responsivity algorithm Alg-y, which is then implemented in the respective spectrometer S.

In certain embodiments, the calibration CAL of at least one or each spectrometer S may additionally include a calibration of a spectral axis x, e.g., a wavelength axis, a wavenumber axis or a frequency axis, of the respective spectrometer S. In this case, the calibration of the spectral axis x is preferably performed before the calibration of the spectral responsivity described above.

Calibrations of the spectral axis of the spectrometers S are, e.g., performed as shown in FIG. 4 with calibration light sources C that are given by line calibration sources exhibiting a known emission spectrum including distinct features at known spectral lines. The line calibration sources employed, e.g., include at least one gas lamp, e.g., a neon or argon lamp, exhibiting known atomic emission lines.

In certain embodiments, at least one or multiple of the calibrations CAL are, e.g., performed as shown in FIG. 4 with calibration light sources C that are given by line and responsivity calibration sources exhibiting a known emission spectrum in a broad spectral range including distinct features at known spectral lines. To this extent, line and responsivity calibration sources disclosed in unpublished U.S. patent application Ser. No. 18/426,611, filed Jan. 30, 2024, and incorporated herein by reference, are e.g., employed. Corresponding line and responsivity calibration sources, e.g., include a broad band light source and a filter imposing an attenuation pattern exhibiting distinct pattern features at multiple spectral reference lines on the light emitted by the broad band light source such that the emission spectrum of the structured light emitted by the line and responsivity calibration source exhibits distinct features corresponding to the pattern features at the multiple spectral reference lines. Line and responsivity calibration sources provide the advantage that calibrations of both the spectral axis x and the spectral responsivity can be performed based on calibration spectra of light emitted by the line and responsivity calibration source.

For each calibration CAL including a calibration of the spectral axis x and a calibration of the spectral responsivity, determining the correction Cor is performed in two steps. The first step includes, based on the calibration measurement(s) performed with the line calibration light source or the line and responsivity calibration light source, determining and implementing a correction Cor-x for correcting assignments of the spectral lines performed by the mapping algorithm Alg-x such that the distinct features included in calibration spectra Ic determined based on the corrected algorithm ALGc occur at the corresponding known spectral lines.

In embodiments of calibration measurements performed with calibration light sources C including the monochromatic light source 1 of the spectrometer S to be calibrated, the excitation wavelength of the light emitted by the light source 1 is, e.g., used as one of the known spectral lines.

The second step includes, based on the calibration measurement(s) performed with the responsivity calibration source or the line and responsivity calibration source, determining and implementing the correction Cor-y for the responsivity algorithm Alg-x as described above based on the mapping algorithm Alg-x and the previously determined correction Cor-x for the mapping algorithm Alg-x.

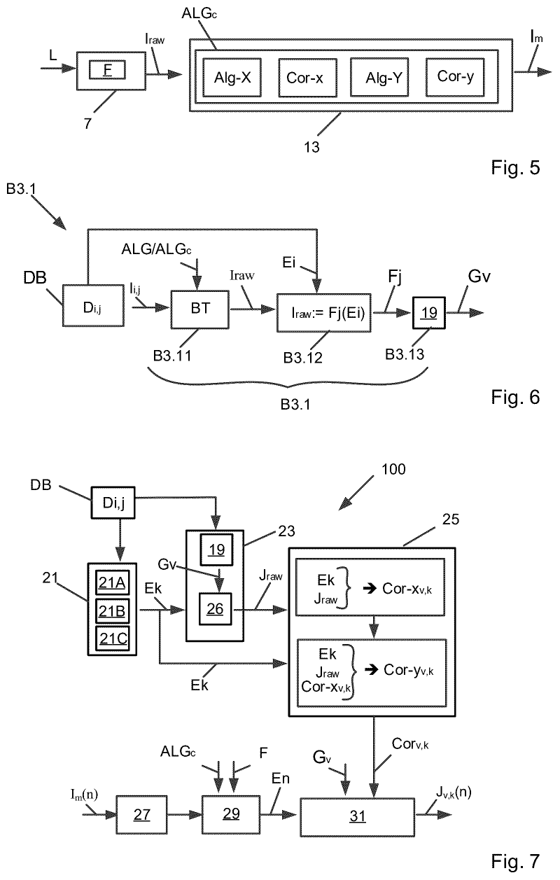

FIG. 5 shows a block-diagram of the processing performed by calibrated spectrometers S. For each calibrated spectrometer S, the processing includes a first process of determining and providing raw spectra I_{raw} of light L received by the spectrometric unit 7 and a second process of determining and providing measured spectra Iₘ based on the raw spectra I_{raw} provided by the spectrometric unit 7.

The first process is performed by the spectrometric unit 7 according to a spectrometer-specific transfer function F of the spectrometer S representing the determination of the spectral values of the raw spectra I_{raw} based on the spectral values of the intensity spectra of the received light L performed by the respective spectrometer S. Due to differences of the technical properties of spectrometers S of the same given type, each individual spectrometer S may perform the determination of the raw spectra I_{raw} according to a different spectrometer-specific transfer function F and the spectrometer-specific transfer function F of each spectrometer S may depend on the measurement conditions to which the spectrometer S is exposed.

The second process is performed by the signal processor 13 determining the measured spectra Iₘ based on the raw spectra I_{raw} and the corrected ALGc. As shown in FIG. 5, executing the corrected algorithm ALGc, e.g., includes a first part of executing the mapping algorithm Alg-x and the correction Cor-x for the mapping algorithm Alg-x followed by a second part of executing the responsivity algorithm Alg-y and the correction Cor-y for the responsivity algorithm Alg-y.

Depending on the type of spectrometer S employed, it may not always be necessary for each calibration CAL to include a calibration of a spectral axis. As an alternative, a mapping function determined and implemented in the algorithm ALG, e.g., in the mapping algorithm Alg-x, by the manufacturer of the spectrometers S and/or a correction Cor-x for the mapping algorithm Alg-x determined during an initial or previous calibration of the spectrometer S may be used instead.

Regardless of the calibration procedure(s) performed, each calibrated spectrometer S is subsequently used in the spectrometric measurement method shown in FIG. 1 to determine measurement results MR of the measurand of the medium at the measurement site, where it is operated. In certain embodiments, the measurement results MR are, e.g., determined by an evaluation unit 17 connected to or communicating with the signal processor 13 providing the measured spectra Iₘ. The evaluation unit 17 is, e.g., a computer, a microprocessor or another type of calculating unit determining and providing the measurement results MR based on the measured spectra Iₘ and the model MOD for determining the measurement result MR that has previously been determined by performing the model determination method shown in FIG. 2. The exemplary evaluation unit 17 shown in FIG. 3 is, e.g., a component of the respective spectrometer S performing the spectroscopic measurements or is a component of a measurement system including at least one or each spectrometer S and the evaluation unit 17 connected to or communicating with the calibrated spectrometer(s) S.

The methods and analyzers of the present disclosure recognize that spectral distributions of measured spectra Iₘ provided by different calibrated spectrometers S of the same type depend on the properties of the medium, the measurement conditions prevailing during the determination of the measured spectra Iₘ, technical properties of respective spectrometer S, and the calibration CAL of the respective spectrometer S. Even if the same calibration procedure is applied in each calibration CAL, the correction Cor determined during the respective calibration CAL depends on the technical properties of respective spectrometer S (e.g., variation in the manufacturing of the spectrometers), the measurement conditions prevailing during the calibration measurements, and the emission spectra emitted by the calibration light source(s) C employed.

As a result, measured spectra Iₘ of the same sample of the medium determined by different calibrated spectrometers S of the same type exhibit a variability VAR caused by variations of the technical properties of the different spectrometers S and by variations of the calibrations CAL of the different spectrometers S. Both contributions to the variability VAR include contributions caused by variations of the measurement conditions to which the spectrometer S is exposed. In the state of the art, this variability VAR leads to measurement errors of variable sizes when a single model is used to determine measurement results MR based on measured spectra Iₘ determined by different calibrated spectrometers S. Corresponding measurement errors of variable size may also occur when the same model is to be used on both before and after consecutive calibrations CAL of the spectrometer S.

These measurement errors and the size of their variations can be significantly reduced by determining the model MOD as shown in FIG. 2 as to properly accounted for the variability VAR exhibited by measured spectra Iₘ determined by different calibrated spectrometers S of the same type.

To this extent, the model determination method shown in FIG. 2 includes a method step B1 of, with multiple calibration light sources Ci exhibiting known emission spectra Ei, calibrating multiple spectrometers Sj of the given type and a method step B2 of recording calibration data D_{i,j} attained by these calibrations CAL_{i,j}.

The calibration CAL_{i,j} of each of the multiple spectrometers Sj is, e.g., performed as described above with respect to the calibration CAL of the spectrometers S. Thus, each calibration CAL_{i,j} includes, with the spectrometer Sj to be calibrated, performing at least one calibration measurement by with the spectrometer Sj determining a calibration spectrum I_{i,j} of light emitted by one of the multiple calibration light sources Ci. In case the respective spectrometer Sj has previously been calibrated, the or each calibration spectrum I_{i,j} is, e.g., determined by the respective spectrometer Sj based on the corrected algorithm ALGc including the algorithm ALG and the correction Cor determined during the previous calibration of the respective spectrometer Sj. In case the respective spectrometer Sj has never been calibrated before, the or each calibration spectrum I_{i,j} is, e.g., determined by the respective spectrometer Sj based on the algorithm ALG. As an option available for spectrometers Sj that are configured accordingly, the or each calibration spectrum I_{i,j} is, e.g., provided by respective spectrometer Sj in form of the corresponding raw spectrum I_{raw} provided by the spectrometric unit 7 or in form of a spectrum determined based on the raw spectrum I_{raw} and the uncorrected algorithm ALG.

Depending on the calibration procedure(s) employed, the multiple calibration light sources Ci used in method step B1, e.g., include multiple line calibration sources, multiple responsivity calibration sources and/or multiple line and responsivity calibration sources.

Recording the calibration data D_{i,j}, e.g., includes, for each of the multiple spectrometers Sj, recording at least one or each calibration spectrum I_{i,j} of the light emitted by one of the calibration light sources Ci determined by the respective spectrometer Sj during its calibration and the corresponding known emission spectrum Ei of the respective calibration light source Ci.

Recording the calibration data D_{i,j}, e.g., further includes for each calibration spectrum I_{i,j} that has been determined based on the corrected algorithm ALGc employed by the spectrometer Sj determining the respective calibration spectrum I_{i,j} recording the correction Cor included in the corrected algorithm ALGc.

In certain embodiments, recording the calibration data D_{i,j}, e.g., includes storing the calibration data D_{i,j} in a data base DB.

Considering that the calibration measurements performed with calibration light sources Ci during the calibrations CAL_{i,j} are unaffected by properties of the medium in the predetermined application, the multiple spectrometers Sj, e.g., include at least one spectrometer S employed or to be employed in the given application and/or at least one spectrometer of the given type employed or to be employed in another application.

The method further includes a method step B3 of, based on the calibration data D_{i,j}, assessing a variability VAR exhibited by measured spectra Iₘ determined by calibrated spectrometers S of the given type. In certain embodiments, this variability VAR is, e.g., determined as a statistical variability to be expected of measured spectra Iₘ determined by a statistically representative number of calibrated spectrometers S of the given type.

In certain embodiments, assessing the variability VAR is, e.g., performed with an analyzer 100 for assessing the variability VAR described in more detail below.

Considering that the calibration data D_{i,j} and correspondingly also the assessment of the variability VAR performed based the calibration data D_{i,j} does not depend on the application-specific properties of the medium in the predetermined application, the method steps B1, B2 and B3 only have to be performed once, and the assessed variability VAR is then available in to be used to determine models for at least one or multiple different applications.

In certain embodiments, assessing the variability VAR, e.g., includes a method step B3.1 of assessing a function variability VF exhibited by the spectrometer-specific transfer functions F of spectrometer S of the given type and a method step B3.2 of assessing a correction variability VC exhibited by corrections Cor for the algorithm ALG employed in calibrated spectrometers S of the given type.

Considering that the spectrometer-specific transfer functions F represent the technical properties of the spectrometers S under the influence of measurement conditions, the function variability VF enables for variations of the technical properties of the spectrometers under the influence of measurement conditions to be properly taken into account. In an analog manner, corrections Cor determined based on calibrations CAL depend on the technical properties of the spectrometers S under the influence of measurement conditions during their calibration CAL and the performance of the respective calibration procedure. Thus, in combination, the function variability VF determined based on the calibration data Di, j and the correction variability VC determined based on the calibration data D_{i,j} and the function variability VF enable for the variability VAR exhibited by measured spectra Iₘ determined by calibrated spectrometers S of the given type to be properly assessed and taken into account.

In certain embodiments, method step B3.1 of assessing the function variability VF is, e.g., performed by, based on the calibration data D_{i,j}, constructing a function generator 19 generating synthetic functions Gv exhibiting the function variability VF. The function generator 19 is, e.g., included in the analyzer 100 and/or, e.g., includes a computer and a computer program, e.g., a processor and instruction code, to be executed by the computer causing the computer to determine and provide synthetic functions Gv exhibiting the function variability VF.

Constructing the function generator 19, e.g., includes designing the function generator 19 such that the generated synthetic transfer functions Gv constitute samples of the same statistical distribution as the spectrometer-specific transfer functions Fj of the multiple spectrometers Sj calibrated in method step B1.

As shown in FIG. 6, in certain embodiments, designing the function generator 19, e.g., includes, based on the calibration data D_{i,j}, determining the spectrometer-specific transfer function Fj of each of the multiple spectrometers Sj that have been calibrated in method step B1 and a method step B3.13 of designing the function generator 19 based on these spectrometer-specific transfer functions Fj.

In this context, the spectrometer-specific transfer function Fj of each of the multiple spectrometers Sj provides the advantage that they reflect the full bandwidth of technical properties exhibited by the multiple spectrometers Sj and their susceptibility to the bandwidth of measurement conditions they were exposed to during their calibrations CAL_{i,j}.

For each of the multiple spectrometer Sj calibrated in method step B1 the respective spectrometer-specific transfer function Fj is, e.g., determined in a two-step process shown in FIG. 6.

The first step B3.11 e.g., includes, based on at least one or each calibration spectrum I_{i,j} determined by the respective spectrometer Sj, re-determining the corresponding raw spectrum I_{raw} based on which the respective calibration spectrum I_{i,j} has been determined. For calibration spectra I_{i,j} that have been determined based on the algorithm ALG or the corrected algorithm ALCc, this is, e.g., achieved by reverse processing the transformations performed by the algorithm ALG or the corrected algorithm ALCc employed by the respective spectrometer Sj to determine the respective calibration spectrum I_{i,j}. The reverse processing is, e.g., performed by applying a backward transformation BT to the respective calibration spectrum I_{i,j} that reverts the transformations performed by the algorithm ALG or the corrected algorithm ALCc. For calibration spectra I_{i,j} that have been provided in the form of the corresponding raw spectrum I_{raw}, the re-determined raw spectrum I_{raw} is determined to be given by the respective calibration spectrum I_{i,j}.

The second step B3.12 includes determining the spectrometer-specific transfer function Fj of the respective spectrometer S based on the re-determined raw spectrum I_{raw} and the known emission spectrum Ei of the calibration light source Ci used during the determination of the respective calibration spectrum I_{i,j}. Each spectrometer-specific transfer function Fj is, e.g., determined such that the transfer function Fj(Ei) of the known emission spectrum Ei corresponds to the respective re-determined raw spectrum I_{raw}.

Designing the function generator 19 is, e.g., performed based on mathematical and/or statistical data analysis methods performed based on the calibration data D_{i,j}. To this extent, methods including multivariate data analysis and/or modelling methods and/or principal component analysis are, e.g., employed.

In certain embodiments, the spectrometer-specific transfer functions Fj determined in method step B3.12 are, e.g., interpreted as a sample of a statistical distribution exhibiting the function variability VF and the function generator 19 is subsequently trained to determine the synthetic functions Gv such that their statistical probability of being samples of the same statistical distribution as the spectrometer-specific transfer functions Fj determined in method step B3.12 is higher than a predetermined minimum probability.

As an alternative, the function generator 19 is, e.g., constructed such that it is designed to learn the determination of synthetic functions Gv exhibiting the function variability VF. In this case, the method, e.g., includes with the function generator 19 executing a machine learning method, wherein the function generator 19 learns the determination of the synthetic functions Gv.

As an example, in certain embodiments, the learning method is, e.g., performed with a generative adversarial network (GANS). The generative adversarial network, e.g., includes a generator configured to learn the generation of functions resembling the spectrometer-specific transfer functions Fj determined in method step B3.12 and a discriminator configured to learn to discriminate between the generated functions and the spectrometer-specific transfer functions Fj. In this case, the generator is, e.g., embodied in form of a first neural network, the discriminator is, e.g., embodied in form of a second neural network, and/or the learning is, e.g., performed based on the spectrometer-specific transfer functions Fj determined in method step B3.12. When this learning method is employed, the generator learns to generate the functions based on the feedback provided by the discriminator such that the discriminator is unable to identify them as generated functions. This way, the generator learns to determine the functions such that they exhibit a statistical variability corresponding to the function variability VF.

Regardless of whether the function generator 19 is configured, trained or designed to learn the generation the synthetic functions Gv, the function generator 19 is subsequently employed to generate and provide the synthetic functions Gv exhibiting the function variability VF. This provides the advantage that only a limited amount of calibration data D_{i,j} is necessary to design the function generator 19 and to properly assess the function variability VF exhibited by spectrometer-specific transfer functions F of a statistically relevant number of spectrometers S of the given type based on the synthetic functions Gv.

In certain embodiments, method step B3.2 of assessing the correction variability VC, e.g., includes, based on the calibration data D_{i,j} recorded in method step B2 and the function variability VF determined in method step B3.1, simulating calibrations of spectrometers S of the given type and, based on each simulated calibration, determining the corresponding correction Cor_{v,k} for the algorithm ALG.

Method step B3.2 is, e.g., performed by the analyzer 100 for assessing the variability VAR being configured to perform the simulations and to determine and provide the correction Cor_{v,k} for the algorithm ALG for each simulated calibration. The analyzer 100, e.g., includes a computer and a computer program to be executed by the computer causing the computer to perform the simulations and to determine and provide the corrections Cor_{v,k}. An exemplary embodiment of the analyzer 100 is shown in FIG. 7.

The analyzer 100 includes a spectrum generator 21 configured to provide emission spectra Ek corresponding to the known emission spectra Ei of the multiple calibration sources Ci.

As mentioned above, the calibration light sources Ci employed in method step B1, e.g., include multiple line calibration light sources, multiple responsivity calibration light sources, and/or multiple line and responsivity calibration light sources. Correspondingly, the spectrum generator 21, e.g., includes a generator for each type of calibration light source Ci employed in method step B1. Thus, in certain embodiments, the spectrum generator 21, e.g., includes a first generator 21A configured to provide emission spectra Ek corresponding to the known emission spectra Ei emitted by the line calibration light sources, a second generator 21B configured to provide emission spectra Ek corresponding to the known emission spectra Ei emitted by the responsivity calibration light sources, and/or a third generator 21C configured to provide emission spectra Ek corresponding to the known emission spectra Ei emitted by the line and responsivity calibration light sources employed in method step B1.

In certain embodiments, the emission spectra Ek provided by the spectrum generator 21 are, e.g., each given by one of the known emission spectra Ei of the multiple calibration sources Ci.

As an alternative, in certain embodiments, the spectrum generator 21 is, e.g., configured to determined and provide emission spectra Ek corresponding to the known emission spectra Ei such that they exhibit a variability corresponding to the variations exhibited by the known emission spectra Ei.

In such embodiments, at least one or each generator 21A, 21B, 21C is, e.g., configured to determine the emission spectra Ek as normalized weighted sums of the known emission spectra Ei of the calibration light sources Ci of the respective type. In this case the weighing factors applied to determine the individual emission spectra Ek are, e.g., randomly generated such that the statistical variability of emission spectra Ek corresponds to the variability exhibited by the known emission spectra Ei emitted by the multiple calibration light sources Ci of the respective type.

As an alternative a more complex determination of the emission spectra Ek may by employed. In such an embodiment, at least one or each generator 21A, 21B, 21C is, e.g., trained to determine the emission spectra Ek based on the known emission spectra Ei of the multiple calibration light sources Ci of the respective type. As an example, in certain embodiments, the known emission spectra Ei of the calibration light sources Ci of the respective type employed in method step B1 are, e.g., interpreted as a sample of a statistical distribution, and the respective generator 21A, 21B, 21C is subsequently trained based on these known emission spectra Ei to determine the emission spectra Ek such that their statistical probability of being samples of the same statistical distribution as the known emission spectra Ei is higher than a predetermined minimum probability.

In addition or as an alternative, at least one or each generator 21A, 21B, 21C is, e.g., designed to learn to the determination of the emission spectra Ek exhibiting the respective variability. To this extent, machine learning methods known in the art may be used.

The analyzer further includes a soft sensor 23 determining synthetic raw spectra J_{raw} of the emission spectra Ek provided by the spectrum generator 21 and an analyzing unit 25 determining and providing the corrections Cor_{v,k} for the algorithm ALG for each simulated calibration based on the or each emission spectrum Ek and on the corresponding synthetic raw spectrum J_{raw} generated during the respective simulated calibration.

In analogy to the calibrations CAL of the spectrometers S described above, for each simulated calibration the corresponding correction Cor_{v,k} is determined by the analyzing unit 25 such that calibration spectra determined based on the or each synthetic raw spectrum J_{raw} and a corrected algorithm ALGc_{v,k} including the algorithm ALG and the correction Cor_{v,k} correspond to the emission spectrum Ek based on which the respective synthetic raw spectrum J_{raw} has been determined.

The soft sensor 23 is preferably configured to determine the synthetic raw spectra J_{raw} of the emission spectra Ek in a manner accounting for the variability of the technical properties exhibited by spectrometer S of the given type. In certain embodiments, this is, e.g., achieved by the soft sensor 23, e.g., including the function generator 19 described above providing synthetic functions Gv for calculating the synthetic raw spectra J_{raw} as a function of the spectral values of the emission spectra Ek and a processing unit 26 determining each synthetic raw spectrum J_{raw} based on one of the emission spectra Ek provided by the spectrum generator 21 and one of the synthetic functions Gv generated by the function generator 19.

In analogy to the calibrations CAL of the spectrometers S described above, each simulated calibration performed with the analyzer 100 either solely includes a calibration of the spectral responsivity or both a calibration of the spectral axis and a calibration of the spectral responsivity.

The performance of each simulated calibration solely including the calibration of the spectral responsivity, e.g., includes, with the spectrum generator 21, generating an emission spectrum Ek suitable for responsivity calibrations, with the soft sensor 23 determining the synthetic raw spectrum J_{raw} of this emission spectrum Ek, and with the analyzing unit 25 determining and providing the correction Cor_{v,k} for the algorithm ALG based on the synthetic raw spectrum J_{raw} and the emission spectrum Ek. Emission spectra Ek suitable for responsivity calibrations are, e.g., provided by the first generator 21A or the third generator 21C, and the corrections Cor_{v,k} determined based on these simulated calibrations are, e.g., determined as corrections Cor-y_{v,k} for the responsivity algorithm Alg-y.

The performance of each simulated calibration including the calibration of the spectral axis x and the calibration of the spectral responsivity, e.g., includes performing a two-step process.

The first step includes, with the spectrum generator 21, generating an emission spectrum Ek suitable for calibrations of the spectral axis, with the soft sensor 23 generating a synthetic function Gv, and based on this synthetic function Gv, determining the synthetic raw spectrum J_{raw} of the emission spectrum Ek. Following this, the analyzing unit 25 then determines the correction Cor-xᵥ for the mapping algorithm Alg-x based on the emission spectrum Ek and the corresponding synthetic raw spectrum J_{raw}.

The second step includes, with the spectrum generator 21, generating an emission spectrum Ek suitable for calibrations of the spectral responsivity and, with the soft sensor 23, determining the synthetic raw spectrum J_{raw} of this emission spectrum Ek, e.g., based on the synthetic function Gv that has been generated in the first step. Following this, the analyzing unit 25 then determines the correction Cor-y_{v,k} for the responsivity algorithm Alg-y based on the previously determined correction Cor-x_{v,k} for the mapping algorithm Alg-x and based on the emission spectrum Ek and the synthetic raw spectrum J_{raw} determined in the second step of the respective simulated calibration.

In this two-step process, emission spectra Ek suitable for calibrations of the spectral axis are, e.g., generated by the first generator 21A or the third generator 21C, and emission spectra Ek suitable for calibrations of the spectral responsivity are, e.g., generated by the second generator 21B or the third generator 21C. Based on this two-step process, the corrections Cor_{v,k} for the algorithm ALG determined by the analyzing unit 25 include the correction Cor-x_{v,k} for the mapping algorithm Alg-x and the correction Cor-y_{v,k} of the responsivity algorithm Alg-y.

Performing the simulated calibrations preferably includes, based on at least one or each synthetic function Gv generated by the function generator 19, determining multiple corrections Cor_{v,k} for the algorithm ALG, which are each determined as described above based on a different set of at least one emission spectrum Ek generated by the spectrum generator 21.

The simulated calibrations as well as the analyzer 100 performing them provide the advantage that the statistical variability of the technical properties of spectrometers S of the given type under different measurement conditions is properly accounted for based on the synthetic functions Gv exhibiting the function variability VF. They further provide the advantage that the statistical variability of calibrations CAL of spectrometers S of the given type is properly accounted for based on the emission spectra Ek and the function variability VF exhibited by the synthetic functions Gv. In combination, this provides the advantage that the corrections Cor_{v,k} determined by the simulated calibrations exhibit a statistical variability corresponding to the correction variability VC exhibited by corrections Cor determined for a statistically representative number of spectrometers S of the given type. This in turn provides the advantage that the variability VAR exhibited by measured spectra Iₘ determined by a statistically representative number of calibrated spectrometers S of the given type can be properly assessed based on the synthetic functions Gv and the corrections Cor_{v,k} determined based on the simulated calibrations.

Determining the synthetic functions Gv and performing the simulated calibrations as described above further provides the advantage that only a limited amount of calibration data D_{i,j} is needed to properly assess the variability VAR exhibited by measured spectra Iₘ. This in turn enables for the number of different calibration light sources Ci used in method step B1, as well as the number of different spectrometers Sj calibrated in method step B1, to be limited accordingly. This reduces the time, the effort and the cost involved in performing method step B1.

Following the preparatory method steps B1, B2 and B3, the method of determining the model MOD according to the present disclosure shown in FIG. 2 further includes a method step B4 of, with at least one spectrometer S of the given type, performing reference measurements of reference samples n of the medium at the given application exhibiting known reference values rₙ of the measurand(s).

As shown in FIG. 2, method step B4 preferably includes: with each spectrometer S employed in method step B4, performing a method step B4.1 of calibrating the respective spectrometer S; a method step B4.2 of, based on the calibration measurement(s) performed during the calibration CAL, determining the spectrometer-specific transfer function F of the respective spectrometer S and the correction Cor for the algorithm ALG; and a method step B4.3 of, with the calibrated spectrometer S, determining and providing reference spectra Iₘ(n) of reference samples n of the medium at the predetermined application exhibiting known reference values rₙ of the measurand(s).

The method further includes a method step B5 of, for each of the reference values rₙ based on at least one or each measured reference spectrum Iₘ(n) of one of the refence samples n exhibiting the respective reference value rₙ and the variability VAR exhibited by measured spectra Iₘ determined by spectrometers S of the given type that has previously been assessed in method step B3, determining a multitude of synthetic spectra J_{v,k}(n) of reference samples exhibiting the respective reference value rₙ of the measurand such that the synthetic spectra J_{v,k}(n) exhibit a variability corresponding to the variability VAR exhibited by measured spectra Iₘ determined by calibrated spectrometers S of the given type.

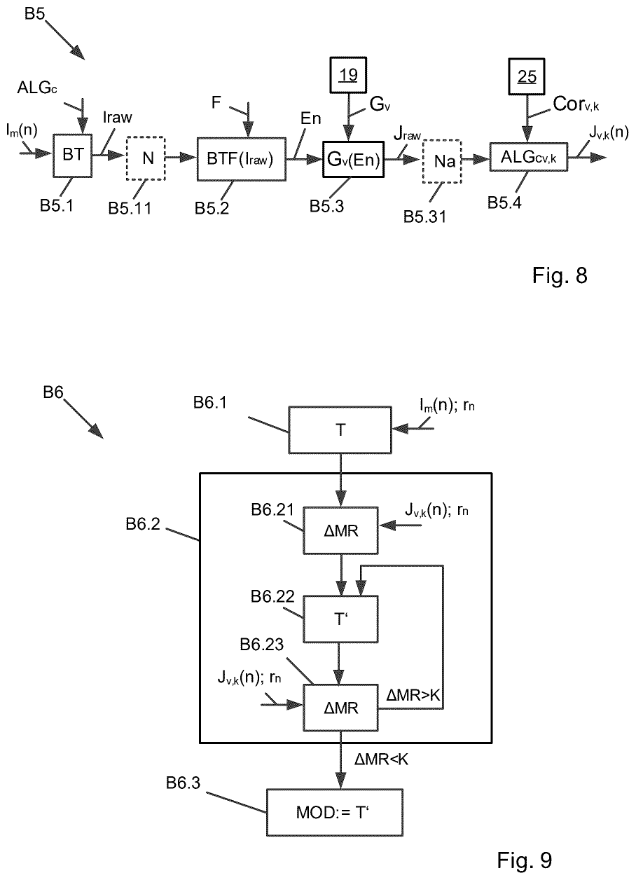

In certain embodiments, method step B5, e.g., includes based on each measured reference spectrum Iₘ(n) determining corresponding synthetic spectra J_{v,k}(n) by performing the method shown in FIG. 8.

The method step B5 includes a first part of, based on the respective measured reference spectrum Iₘ(n), re-determining the light spectrum En of the light received by the spectrometer S based on which the respective measured reference spectrum Iₘ(n) has been determined by the spectrometer S and a second part of, based on the re-determined light spectrum En, determining multiple synthetic spectra J_{v,k}(n).

As shown in FIG. 8, the first part e.g., includes a method step B5.1 of, based on the reference spectrum Iₘ(n), re-determining the raw spectrum I_{raw} based on which the reference spectrum Iₘ(n) has been determined. For each reference spectrum Iₘ(n), the corresponding raw spectrum I_{raw} is, e.g., determined by reverse processing the transformations performed by the corrected algorithm ALCc employed by the calibrated spectrometer S that determined the reference spectrum Iₘ(n). The reverse processing is, e.g., performed by applying a backward transformation BT to the respective reference spectrum Iₘ(n) that reverts the transformations performed by the corrected algorithm ALCc.

The method step of re-determining the raw spectra I_{raw} is obviously not necessary in instances where the raw spectra I_{raw} are available. In such a case, the method step B5.1 of re-determining the raw spectra I_{raw} is e.g., replaced by a method step of providing the raw spectra I_{raw} determined by the spectrometer(s) S performing the reference measurements on the reference samples n.

The first part further includes a method step B5.2 of, based on the raw spectrum I_{raw} determined in method step B5.1, re-determining the light spectrum En of the light received by the spectrometric unit 7 based on which the respective reference spectrum Iₘ(n) has been determined by the spectrometer S. For each raw spectrum I_{raw}, the corresponding light spectrum En is, e.g., re-determined by applying a backward transformation BTF to the raw spectrum I_{raw} that reverts the transformations performed by the spectrometer-specific transfer function F that has previously been determined in method step B4.2 for the respective spectrometer S.

In the second part of method step B5, the determination of the synthetic spectra J_{v,k}(n) is, e.g., performed by performing a method step B5.3 of, based on the re-determined light spectrum En, determining a synthetic raw spectrum J_{raw} by applying one of the synthetic functions Gv generated in the simulated calibrations to the re-determined light spectrum En, e.g., by J_{raw}:=Gv(En), and a method step B5.4 of, based on the synthetic raw spectrum J_{raw}, determining at least one or multiple synthetic spectra J_{v,k}(n). Each of these synthetic spectra J_{v,k}(n) is, e.g., determined based on a corrected algorithm ALCc_{v,k} including the algorithm ALG and one of the corrections Cor_{v,k} that was determined by the analyzing unit 25 based on a simulated calibration performed by the analyzer 100, e.g., based on the synthetic function Gv employed in method step B5.3 to determine the synthetic raw spectrum J_{raw}.

In certain embodiments, the analyzer 100 is configured to determine and to provide the synthetic spectra J_{v,k}(n). In such an embodiment, the analyzer 100 further includes an input port 27 for receiving the measured reference spectra Iₘ(n), a reverse-processing unit 29 and a forward-processing unit 31.

The reverse-processing unit 29 is configured to reverse-process each reference spectrum Iₘ(n) and to thereby re-determine the light spectrum En based on which the respective reference spectrum Iₘ(n) has been determined by the respective spectrometer S. This reverse-processing is, e.g., performed by the reverse-processing unit 29 being configured to perform the method steps B5.1 and B5.2 shown in FIG. 8.

The forward-processing unit 31 is configured to forward-process the re-determined light spectra En provided by the reverse processing-unit 29 and to thereby determine the synthetic spectra J_{v,k}(n). This forward-processing is, e.g., performed by the forward-processing unit 29 being configured to perform the method steps B5.3 and B5.4 shown in FIG. 8.

In certain embodiments, the determination of the synthetic spectra J_{v,k}(n) is, e.g., performed in a manner accounting for influences of noise on measured spectra Iₘ determined by spectrometers S of the given type. This noise, e.g., includes noise due to disturbances occurring along the light propagation path along which the measurement light L_{M} is received by the spectrometric units 7, as well as noise due to the processing performed by the spectrometric units 7 determining the raw spectra I_{raw}. The latter is, e.g., caused by the signal to noise ratio inherent to the individual detector elements of the detector 11.

As shown in FIG. 8, in such embodiments, the reverse processing performed by the reverse-processing unit 29, e.g., includes an additional method step B5.11 of removing noise N included in the reverse processed signals and the forward processing performed by the forward-processing unit 31, e.g., includes an additional method step B5.31 of adding artificial noise Na to the forward-processed signals.

In certain embodiments, method step B5.11 of removing the noise N is, e.g., performed by filtering the re-determined raw spectra I_{raw}. To this extent noise filters, e.g., smoothing filters, known in the art may be used. In addition or as an alternative, in certain embodiments, method step B5.31 of adding artificial noise Na is, e.g., performed by adding the artificial noise Na to the synthetic raw spectra J_{raw}. In certain embodiments, the artificial noise Na is, e.g., added in form of randomly generated noise spectra, e.g., spectra including randomly generated spectral values, e.g., spectral values exhibiting a predetermined distribution, e.g., a Gaussian distribution or a distribution determined based on an analysis of noise included in raw spectra I_{raw} determined by spectrometers S of the given type.

As shown in FIG. 2, the method further includes a method step B6 of determining and providing the model MOD for determining measurement results MR based on the reference spectra Iₘ(n) determined in method step B4 and the corresponding reference values rₙ of the measurand(s) and based on the synthetic spectra J_{v,k}(n) determined in method step B5 and the corresponding reference values rₙ of the measurand(s).

With respect to the model determination performed in method step B6, methods employed in the prior art to determine models based on measured reference spectra may be used. As an example, in certain embodiments, the model MOD is, e.g., determined based on training data including the reference spectra Iₘ(n), the synthetic spectra J_{v,k}(n) and the corresponding reference values rₙ by, based on a detailed analysis of this training data, determining and providing an algorithm for calculating measurement results MR of the measurand(s) based on the spectral values of measured spectra Iₘ of the medium. In certain embodiments, the analysis of the training data and/or the determination of the model MOD, e.g., includes performing a multivariate analysis and/or a principle component analysis of the reference spectra Iₘ(n) and the synthetic spectra J_{v,k}(n) and/or performing a method step of quantitatively assessing interdependencies between spectral values of training spectra including the reference spectra Iₘ(n) and the synthetic spectra J_{v,k}(n) and the corresponding reference values rₙ of the measurand(s). This model determination differs from the methods employed in the prior art in that the variability VAR exhibited by measured spectra Iₘ determined by different calibrated spectrometers S of the given type is accounted for by the training data additionally including the synthetic spectra J_{v,k}(n) and the corresponding reference values rₙ.

As an alternative, in certain embodiments, the model MOD is, e.g., determined in method step B6 by performing the method shown in FIG. 9, which includes: a method step B6.1 of, based on the measured reference spectra Iₘ(n) and the corresponding reference values rₙ, determining a test model T; a method step B6.2 of testing and refining the test model T based on training data including at least some of the synthetic spectra J_{v,k}(n) and the corresponding reference values rₙ; and a method step B6.3 of providing the model MOD given by refined test model T′ determined in method step B6.2.

Testing the test model T, e.g., includes based on a data set including at least some of the synthetic spectra J_{v,k}(n) and the corresponding reference values rₙ determining measurement errors ΔMR of measurement results MR determined based on the synthetic spectra J_{v,k}(n) and the test model T.

Refining the test model T, e.g., includes amending the test model T in a manner that reduces the measurement errors ΔMR of measurement results MR determined based on the synthetic spectra J_{v,k}(n). In certain embodiment, amending the test model T, e.g., includes adjusting weighing factors, parameters, filters, smoothing algorithms and/or other model components of the test model T in a manner reducing and/or minimizing the measurement errors ΔMR.

In certain embodiments, the method step B.6.2 of testing and refining the test model T, e.g., includes performing an iterative process of repeatedly performing a method step B6.21 of testing the test model and a method step B6.22 of refining the test model T until the measurement errors ΔMR of measurement results MR determined based on the synthetic spectra J_{v,k}(n) and the refined model T′ are smaller than a predetermined threshold K. In this case, the first iteration is performed based on the test model T and each consecutive iteration is performed based on the refined model T′ determined during the previous iteration.

Regardless of whether the model MOD is determined in method step B6 directly based on the based on training data including the reference spectra Iₘ(n), the synthetic spectra J_{v,k}(n) and the corresponding reference values rₙ or by performing the method steps B6.1, B6.2, B6.3 shown in FIG. 9, due to the synthetic spectra J_{v,k}(n) exhibiting the variability VAR exhibited by measured spectra Iₘ determined by calibrated spectrometers S of the given type, the model MOD determined by the method shown in FIG. 2 is very robust with respect to variations of measured spectra Iₘ determined by different calibrated spectrometers S of the given type. This way a reliably high measurement accuracy is achieved with the model MOD regardless of the number of different calibrated spectrometers S used in the predetermined application to determine the measured spectra Iₘ.

As an option, in certain embodiments, the model determination method of FIG. 2 may further include a method step B7 of verifying the model MOD based on additional measured reference spectra Iₘ₂(n) of reference samples n of the medium exhibiting known reference values rₙ of the measurand(s) that are determined and provided by a different set of at least one or multiple spectrometer(s) S than the reference spectra Iₘ(n) employed to determine the model MOD. As shown in FIG. 2, the optional verification of the model MOD, e.g., includes a method step B7.1 of, with the different set of at least one spectrometers S, determining the additional reference spectra Iₘ₂(n) and includes a method step B7.2 of determining measurement errors ΔMR_{MOD} of measurement results MR determined based on the additional reference spectra Iₘ₂(n) and the previously determined model MOD.

In such embodiments, the model MOD is verified when the thus determined measurement errors ΔMR_{MOD} are smaller than the predetermined threshold K.

In certain embodiments, the method may further include a method step of refining the previously determined model MOD in case it was not verified, e.g., because the measurement errors ΔMR_{MOD} determined in method step B7.2 exceeded the predetermined threshold K. This refinement is, e.g., performed as described above in context with the refinements of the test model T based on the reference spectra Iₘ(n), the additional reference spectra Iₘ₂(n), and additional synthetic spectra J_{v,k}(n) determined as described above based on the additional reference spectra Iₘ₂(n).

Following the determination of the model MOD, the model MOD is then provided, which has the advantage that it is universally applicable at any measurement site in the predetermined application. In this context, the model MOD provides the advantage that it repeatedly provides accurate measurement results MR based on measured spectra Iₘ determined by the different calibrated spectrometers S employed at the individual measurement sites, as well as based on measured spectra Iₘ determined by individual calibrated spectrometers S before and after they are re-calibrated and/or re-placed by calibrated replacement spectrometers S.

In this respect, in certain embodiment of the spectrometric measurement method shown in FIG. 1, e.g., includes: a method step A4 of calibrating at least one additional spectrometer S; a method step A5 of, with the or each additional spectrometer S, determining measured spectra Iₘ of the medium at a further measurement site in the predetermined application; and a method step A6 of determining measurement results MR of the measurand based on measured spectra Iₘ provided by the or each additional calibrated spectrometer S and the model MOD.

In addition or as an alternative, in certain embodiments, the spectrometric measurement method shown in FIG. 1 e.g., includes at least once re-calibrating at least one of the calibrated spectrometers S and/or the calibrated additional spectrometers S employed by repeating the method step A1, A4 of calibrating the spectrometer S, and subsequently performing the method step A2, A5 of determining measured spectra Iₘ with the re-calibrated spectrometer(s) S and the method step A3, A6 of determining the measurement results MR based on the measured spectra Iₘ provided by the re-calibrated spectrometer S and the model MOD.

In addition or as an alternative, in certain embodiments, the spectrometric measurement method e.g., includes at least once replacing at least one of the spectrometers S and/or the additional spectrometer(s) S employed and subsequently performing the method step A1, A4 of calibrating the spectrometer S, the method step A2, A5 of determining measured spectra Iₘ and the method step A3, A6 of determining the measurement results MR with the respective replacement spectrometer.

In FIG. 1, the optional re-calibrations and/or replacements are indicated by arrows P1, P2.

In this context, the robustness of the model MOD with respect to the variability VAR exhibited by measured spectra Iₘ determined by calibrated spectrometers S of the given type provides the advantage that at least approximately the same high measurement accuracy of the measurement results MR is achieved with each calibrated spectrometer S, with each calibrated additional spectrometer S, with each re-calibrated spectrometer S as well as with each calibrated replacement spectrometer S based on the single model MOD employed to determine all of these measurement results MR.

Each of the signal processor 13, evaluation unit 17, function generator 19, analyzing unit 25, processing unit 26, reverse-processing unit 29, forward-processing unit 31, and other units described herein may be a portion of a processing subsystem that includes one or more computing devices having memory, processing, and/or communication hardware. Each may be a single device or a distributed device, and the functions of each may be performed by hardware and/or software. Each may include one or more arithmetic logic units (ALUs), central processing units (CPUs), memories, limiters, conditioners, filters, format converters, or the like which are not shown to preserve clarity. In at least one embodiment, one or more of the signal processor 13, evaluation unit 17, function generator 19, analyzing unit 25, processing unit 26, reverse-processing unit 29, forward-processing unit 31, and other units described herein are programmable to execute algorithms and process data in accordance with operating logic that is defined by programming instructions, such as software or firmware. Alternatively or additionally, operating logic for the units may be at least partially defined by hardwired logic or other hardware, for example, using an application-specific integrated circuit (ASIC) of any suitable type. Each may be exclusively dedicated to the functions described herein or may be further used in the regulation, control, and activation of one or more other subsystems or aspects of the analyzers and spectrometers of the present disclosure.

While various embodiments of an analyzer and methods for using and constructing the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. The present disclosure is not intended to be exhaustive or to limit the scope of the subject matter of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible and thus remain within the scope of the present disclosure.

1. A spectrometric measurement method, the method comprising:
determining a model for determining measurement results of at least one measurand of a medium in a predetermined application based on measured spectra of the medium determined by calibrated spectrometers of a given type, each calibrated spectrometer including a spectrometric unit configured to determine raw spectra of incident light according to a spectrometer-specific transfer function and a signal processor configured to determine the measured spectra based on the raw spectra and a corrected algorithm, including an algorithm and a correction for the algorithm determined during the latest calibration of the respective spectrometer,
wherein determining the model comprises:
with multiple calibration light sources exhibiting known emission spectra, performing calibrations of multiple spectrometers of the given type;
recording calibration data attained from the calibrations, including:
for each of the multiple spectrometers, recording at least one or each calibration spectrum of light emitted by one of the calibration light sources determined by the respective spectrometer during its calibration and the corresponding known emission spectrum of the respective calibration light source; and
for each calibration spectrum determined based on the corrected algorithm employed by the respective spectrometer determining the respective calibration spectrum, recording the respective correction;
based on the calibration data, assessing a variability exhibited by measured spectra determined by calibrated spectrometers of the given type;
with at least one spectrometer of the given type, determining reference spectra of reference samples of the medium exhibiting known reference values of the at least one measurand;
based on the reference spectra and the previously assessed variability, determining synthetic spectra of reference samples exhibiting the previously assessed variability;
determining the model based on the measured reference spectra, the synthetic spectra, and the corresponding reference values; and
providing the model.

2. The method according to claim 1, wherein assessing the variability comprises:
based on the calibration data, assessing a function variability exhibited by spectrometer-specific transfer functions of spectrometers of the given type; and
based on the calibration data and the function variability assessing a correction variability exhibited by corrections for the algorithm employed in calibrated spectrometers of the given type.

3. The method according to claim 2, further comprising:
constructing a function generator adapted to generate synthetic functions exhibiting the function variability, wherein constructing the function generator includes, based on the calibration data, configuring the function generator such that the generated synthetic functions constitute samples of the same statistical distribution as the spectrometer-specific transfer functions of spectrometers of the given type; and
assessing the function variability based on the synthetic functions generated by the function generator.

4. The method according to claim 2, wherein assessing the function variability comprises:
based on the calibration data, determining the spectrometer-specific transfer function of each of the multiple spectrometers; or
determining the spectrometer-specific transfer function of each of the multiple spectrometers by, based on at least one calibration spectrum determined by the respective spectrometer, re-determining the corresponding raw spectrum based on which the respective calibration spectrum has been determined by the respective spectrometer by reverse processing the transformations performed by the algorithm or the corrected algorithm employed by the respective spectrometer to determine the respective calibration spectrum and, based on the re-determined raw spectrum and the known emission spectrum of the calibration light source used during the determination of the respective calibration spectrum, determining the respective spectrometer-specific transfer function.

5. The method according to claim 3, further comprising:
based on the calibration data, determining the spectrometer-specific transfer function of each of the multiple spectrometers; and
configuring the function generator based on the spectrometer-specific transfer function of each of the multiple spectrometers and/or by one of:
performing a method of interpreting the spectrometer-specific transfer functions of the multiple spectrometers as samples of a statistical distribution and, based on these spectrometer-specific transfer functions, training the function generator to determine the synthetic functions such that their statistical probability of being samples of this statistical distribution is higher than a predetermined minimum probability;
performing a machine learning method, wherein the function generator learns the determination of the synthetic functions; and
with a generative adversarial network including a generator configured to learn the generation of functions resembling the spectrometer-specific transfer functions of the multiple spectrometers and a discriminator configured to learn to discriminate between the generated functions and the spectrometer-specific transfer functions of the multiple spectrometers, performing a learning method, wherein the generator learns to generate the synthetic functions based on the feedback provided by the discriminator such that the discriminator is unable to identify them as generated functions.

6. The method according to claim 2, wherein assessing the correction variability includes, based on the calibration data and the previously assessed function variability:
with an analyzer, simulating calibrations of spectrometers of the given type;
based on each simulated calibration, determining the corresponding correction for the algorithm; and
assessing the correction variability based on the corrections determined based on the simulated calibration.

7. The method according to claim 6, further comprising:
constructing a function generator adapted to generate synthetic functions exhibiting the function variability, wherein constructing the function generator includes, based on the calibration data, configuring the function generator such that the generated synthetic functions constitute samples of the same statistical distribution as the spectrometer-specific transfer functions of spectrometers of the given type:
wherein:
each simulated calibration includes simulating at least one calibration measurement by, with a spectrum generator configured to provide emission spectra corresponding to the known emission spectra of the calibration light sources included in the calibration data, generating an emission spectrum, with the function generator generating a synthetic function, and based on the synthetic function provided by the function generator, determining a synthetic raw spectrum of the emission spectrum provided by the spectrum generator; and
for each simulated calibration, determining the corresponding correction for the algorithm includes, based on the or each simulated calibration measurement performed during the respective simulated calibration, determining the correction such that calibration spectra determined based on the or each synthetic raw spectrum and a corrected algorithm including the algorithm and the correction each correspond to the respective emission spectrum based on which the respective synthetic raw spectrum has been determined.

8. The method according to claim 7, wherein:
each simulated calibration is performed based on a single one of the synthetic functions generated by the function generator; and/or
performing the simulated calibrations includes, based on each synthetic function generated by the function generator, determining multiple corrections for the algorithm, which are each determined based on the same synthetic function and a different set of at least one emission spectrum provided by the spectrum generator.

9. The method according to claim 7, wherein:
with the at least one spectrometer of the given type, determining the reference spectra includes:
calibrating each spectrometer based on the calibration of each spectrometer determining the spectrometer-specific transfer function of the respective spectrometer and the correction for the algorithm of the respective spectrometer; and
with the calibrated spectrometer(s), determining and providing the reference spectra of the reference samples of the medium; and/or
determining the synthetic spectra includes, for at least one or each measured reference spectrum:
re-determining a light spectrum of the light received by the respective spectrometer based on which the respective reference spectrum has been determined by reverse processing the processing of the received light performed by the respective spectrometer, or by performing a reverse processing method including providing the raw spectrum, based on which the reference spectrum has been determined or re-determining the raw spectrum based on which the reference spectrum has been determined, by reverse processing the transformations performed by the algorithm or the corrected algorithm employed by the respective spectrometer to determine the reference spectrum, and applying a backward transformation to the provided or re-determined raw spectrum that reverts the transformations performed by the spectrometer-specific transfer function of the respective spectrometer; and
based on the re-determined light spectrum determining multiple synthetic spectra, wherein each synthetic spectrum is determined by performing a forward processing method including determining a synthetic raw spectrum by applying one of the synthetic functions generated in the simulated calibrations to the re-determined light spectrum and determining the respective synthetic spectrum based on the synthetic raw spectrum and a corrected algorithm including the algorithm and one of the corrections that has determined based on one of the simulated calibrations.

10. The method according to claim 9, wherein:
the reverse processing or the reverse processing method includes removing noise included in the reverse processed signals or removing noise include in the provided or re-determined raw spectra; and
the forward processing method includes adding artificial noise to the forward processed signals or adding artificial noise to the synthetic raw spectra.

11. The method according to claim 7, wherein:
the algorithm includes a mapping algorithm assigning spectral lines to the spectral values of the raw spectra provided by the spectrometric unit and a responsivity algorithm determining the spectral values of the measured spectra based on the spectral values of the raw spectra and the spectral lines assigned to them;
each simulated calibration either includes a responsivity calibration or includes a calibration of the spectral axis followed by a responsivity calibration and each correction determined based the simulated calibration either includes a correction for the responsivity algorithm or includes a correction for the mapping algorithm and a correction for the responsivity algorithm;
the multiple calibration light sources include multiple responsivity calibration source exhibiting known emission spectra in a broad spectral range, multiple line calibration sources exhibiting known emission spectra including distinct features at known spectral lines, and/or multiple line and responsivity calibration sources exhibiting known emission spectra including distinct features at known spectral lines in a broad spectral range; and/or
the emission spectra provided by the spectrum generator including at least one of:
emission spectra that are each given by one of the known emission spectra of the multiple calibration light sources; and
synthetic emission spectra determined by the spectrum generator and/or including synthetic emission spectra exhibiting a variability corresponding to the variability exhibited by the known emission spectra of the line calibration source, synthetic spectra exhibiting a variability corresponding to the variability exhibited by the known emission spectra of the responsivity calibration sources, and/or synthetic spectra exhibiting a variability corresponding to the variability exhibited by the known emission spectra of the line and responsivity calibration sources.

12. (canceled)

13. (canceled)

14. (canceled)

15. (canceled)

16. The method according to claim 1, wherein determining the model comprises:
based on the measured reference spectra and the corresponding reference values, determining a test model;
performing at least one of testing and refining the test model based on training data including at least some of the synthetic spectra and the corresponding reference values and, based on training data including at least some of the synthetic spectra and the corresponding reference values, performing a process of repeatedly performing a method step of testing the test model and a method step of refining the test model until measurement errors of measurement results determined based on the synthetic spectra and the refined model are smaller than a predetermined threshold; and
providing the model given by the refined test model.

17. The method according to claim 1, further comprising verifying the model by:
with a different set of at least one spectrometer than the spectrometer(s) employed to determine the reference spectra, determining additional reference spectra of reference samples of the medium exhibiting known reference values;
determining measurement errors of measurement results determined based on the additional reference spectra and the previously determined model; and
performing at least one of:
verifying the model when the measurement errors are smaller than a predetermined threshold; and
refining the model and providing the refined model when the measurement errors exceed the predetermined threshold.

18. The method according to claim 1, further comprising, with at least one or multiple spectrometers to be employed at measurement sites in the predetermined application, calibrating each spectrometer, with each calibrated spectrometer determining and providing measured spectra of the medium, and based on the measured spectra and the previously determined model, determining and providing measurement results of the at least one measurand.

19. The method according to claim 14 further comprising at least one of:
at least once calibrating at least one additional spectrometer, with each calibrated additional spectrometer determining measured spectra of the medium, and based on the measured spectra determined by the calibrated additional spectrometer(s) and the previously determined model, determining and providing measurement results of the at least one measurand;
at least once re-calibrating at least one calibrated spectrometer and/or at least one calibrated additional spectrometer, with the or each re-calibrated spectrometer determining and providing measured spectra of the medium, and based on the measured spectra determined by the re-calibrated spectrometer(s) and the previously determined model, determining and providing measurement results of the at least one measurand; and
at least once:
replacing at least one calibrated spectrometer and/or at least one calibrated additional spectrometer by a replacement spectrometer;
calibrating each replacement spectrometer, with each calibrated replacement spectrometer determining measured spectra of the medium; and
based on the measured spectra determined by the calibrated replacement spectrometer(s) and the previously determined model, determining and providing measurement results of the at least one measurand.

20. An analyzer for assessing a variability exhibited by measured spectra determined by calibrated spectrometers of a given type, each spectrometer including a spectrometric unit configured to determine raw spectra of incident light according to a spectrometer-specific transfer function and a signal processor configured to determine measured spectra based on the raw spectra and an algorithm, wherein the analyzer has been configured based on calibration data to perform simulated calibrations of spectrometers of the given type and to perform the simulated calibrations by, with multiple calibration light sources exhibiting known emission spectra, performing calibrations of multiple spectrometers of the given type, the analyzer comprising:
a spectrum generator configured to provide emission spectra corresponding to the known emission spectra of the calibration light source included in the calibration data and/or including synthetic spectra determined by the spectrum generator and exhibiting a variability corresponding to the variability exhibited by known emission spectra of the multiple calibration light sources;
a soft sensor comprising a function generator and a processing unit,
wherein the function generator is configured to determine and to provide synthetic functions exhibiting a function variability exhibited by the spectrometer-specific transfer functions of spectrometer of the given type, wherein the function generator has been configured, has been trained, or has learned based on the calibration data to generate the synthetic functions such that they constitute samples of the same statistical distribution as the spectrometer-specific transfer functions of the multiple spectrometers, and
wherein the processing unit is configured to determine and to provide synthetic raw spectra of the emission spectra provided by the spectrum generator based on the synthetic functions generated by the function generator; and
an analyzing unit configured to determine and provide a correction for the algorithm for each simulated calibration performed by the analyzer by, based on the or each emission spectrum provided by the spectrum generator and the corresponding synthetic raw spectrum generated by the soft sensor during the respective simulated calibration, determining the correction such that calibration spectra determined based on the or each synthetic raw spectrum and a corrected algorithm including the algorithm and the correction correspond to the emission spectrum based on which the respective synthetic raw spectrum has been determined.

21. The analyzer according to claim 20, wherein:
the calibration light sources employed in the calibrations of the multiple spectrometers include multiple calibration light sources of the or each type of calibration light source employed in the calibrations;
the type(s) of calibration light source(s) employed include at least one of responsivity calibration light sources, line calibration light sources and responsivity calibration light sources, and line and responsivity calibration light sources;
the spectrum generator includes a generator for the or each type of calibration light source employed; and
at least one or each generator included in the spectrum generator is:
configured to provide emission spectra that are each given by one of the known emission spectra of the multiple calibration light sources of the respective type;
configured to determine and provide emission spectra given by normalized weighted sums of the known emission spectra of the multiple calibration light sources of the respective type; or
configured, trained, or has learn to determine and to provide emission spectra exhibiting a variability corresponding to the variability exhibited by known emission spectra of the multiple calibration light sources of the respective type.

22. The analyzer according to claim 20, further comprising:
an input port for receiving measured reference spectra of reference sample determined by spectrometers of the given type,
a reverse-processing unit configured to reverse-process each reference spectrum and to thereby re-determine a light spectrum of light received by the spectrometric unit of the spectrometer, based on which the reference spectrum has been determined by the respective spectrometer; and
a forward processing unit configured to forward-process the re-determined light spectra provided by the reverse processing unit and to thereby determine multiple synthetic spectra, wherein each synthetic spectrum is determined by the forward processing unit:
determining a synthetic raw spectrum by applying one the synthetic functions generated by the function generator during the simulated calibrations to the re-determined light spectrum; and
determining the respective synthetic spectrum by applying a corrected algorithm including the algorithm and one of the corrections that has determined by the analyzing unit based on one of the simulated calibrations to the synthetic raw spectrum.
